(19) United States
(12) Patent Application Publication
(10) Pub. No.: US 2016/0131173 A1
(43) Pub. Date: May 12, 2016

(54) LOCKING NUT SET AND PRODUCTION METHOD THEREFOR

(71) Applicant: SGG R&D CO., LTD, Hamamatsu-shi (JP)

(72) Inventor: Isao Shirayanagi, Hamamatsu-shi (JP)

(21) Appl. No.: 14/981,007

(22) Filed: Dec. 28, 2015

Related U.S. Application Data
(63) Continuation of application No. PCT/JP2014/063863, filed on May 26, 2014.

(30) Foreign Application Priority Data
Jul. 3, 2013 (JP) 2013-139398

(51) Int. Cl. F16B 29/00; B21D 22/02

(52) U.S. Cl. CPC F16B 29/00; B21D 22/02

(57) ABSTRACT

The base nut includes a regular hexagonal column as a peripheral portion of the base nut and a rolled internal thread that is formed in a center shaft core of the base nut. A lower end surface of the regular hexagonal column is a plane perpendicular to the shaft core. On an upper end surface of the regular hexagonal column, a radius RBB, which is concentric with an imaginary osculating circle having a radius RA substantially perpendicular to a bolt axis and which is smaller than the radius RA by an amount equal to a space, forms at least half or more of a circumference of the imaginary osculating circle. In a remaining portion, a radius RCC, which is smaller than the radius RBB, is in contact with the imaginary osculating circle, and a rib-shaped inclined cam, which is continuous with the radius RBB, is formed. A portion of the inclined cam that is in contact with the imaginary osculating circle in a sectional view in an axial direction includes a convex surface having a radius RD.

### FIELD

The present invention relates to a structural improvement and a production method that are capable of removing a factor that causes variations in the locking performance of a nut, and more particularly to metal molds for cold heading, the quality of cold heading, energy saving and material saving in cold heading.

### BACKGROUND

Although a large number of locking nut systems have been proposed and put to practical use, all the systems are configured to prevent a nut from being loosened by generating a frictional force by using the axial tension of a bolt. In 1985, inventions that use the bending force of a bolt and that are prototypes of the present invention were disclosed (see, for example, PTL 1 and PTL 2).

Eventually, like the present invention, improvements in the machining efficiency of a turning method and the like have become popular since around 2005. However, none of these has been mechanically analyzed and none has led to a structural improvement that is required for essential functions (see, for example, PTL 3 and NPL 1).

In addition, the plastic working technology made rapid progress at a later time. As a result, cold heading using a multistage former has become widely used, and a rethinking of the technology from the standpoint of depletion of resources, the environment, and energy has begun.

### CITATION LIST

### Patent Literature

PTL 1: Japanese Examined Utility Model Registration Application Publication No. 50-36123

PTL 2: Japanese Examined Patent Application Publication No. 3-526

PTL 3: Japanese Patent No. 4638777

### Non Patent Literature

NPL 1: “Hertz Formula” Mechanical Engineers' Handbook A4-109 published by the Japan Society of Mechanical Engineers

### SUMMARY

A problem to be solved by the present invention is variations in tightening torque and locking performance that occur due to an inclination of a torque nut 40, which occurs due to a clearance between an external thread and an internal thread, and an inclination of a base nut 20, which occurs due to the deformation of a rolled internal thread mainly caused by a tapping operation using a bent shank tap. There is a need for a structure of a nut set that enables an unskilled person to perform uniform and certain fastening.

In addition, there has been an urgent need for a production method that is capable of supplying a nut set having international competitiveness, such as stable quality, cost reduction, weight reduction, energy saving, operation safety, and risk reduction.

Regarding the relationship between the production method and the produced structure, problems have been solved as a result of new structures being generated owing to advances in the production method.

A main problem can be solved by a locking nut set 10 including a base nut 20 and a torque nut 40.

The base nut 20 includes a regular hexagonal column 21 as a peripheral portion of the base nut 20 and a rolled internal thread 22 that is formed in a center shaft core 24 of the base nut 20. A lower end surface 23 of the regular hexagonal column 21 is a plane perpendicular to the shaft core 24. On an upper end surface 25 of the regular hexagonal column 21, a radius RBB, which is concentric with an imaginary osculating circle 64 having a radius RA substantially perpendicular to a bolt axis 63 and which is smaller than the radius RA by an amount equal to a space s, forms at least half or more of a circumference of the imaginary osculating circle 64. In a remaining portion, a radius RCC, which is smaller than the radius RBB, is in contact with the imaginary osculating circle 64, and a rib-shaped inclined cam 26, which is continuous with the radius RBB, is formed. A portion of the inclined cam 26 that is in contact with the imaginary osculating circle 64 in a sectional view in an axial direction includes a convex surface having a radius RD.

The torque nut 40 includes a regular hexagonal column 41 as a peripheral portion of the torque nut 40 and a rolled internal thread 42 that is formed in a center shaft core 44 of the torque nut 40. An upper end surface 43 and a lower end surface 45 of the regular hexagonal column 41 are each a plane perpendicular to the shaft core 44. The torque nut 40 includes a conical recessed surface 46, which extends from the lower end surface 45 and has the shaft core 44 as a center of the conical recessed surface 46 and a conical inclination angle θ.

The locking nut set 10 has a structure in which the base nut 20 is tightened first onto a bolt 60 in such a manner as to generate a desired axial tension PT, and after that, the torque nut 40 is tightened.

Alternatively, by simplifying the structure of the locking nut set 10 described in [0012], a structure in which an upper portion of the portion of the inclined cam 26 that is in contact with the imaginary osculating circle 64 in the sectional view in the axial direction is a rounded surface RF facing the upper end surface may be employed.

In addition, by enhancing the structure of the locking nut set 10 described in [0012] and forming the rib-shaped inclined cam 26 that is in contact with the imaginary osculating circle 64 and is continuous with the radius RB, the rib-shaped inclined cam 26 including two noses each having a radius RC2, which is smaller than the radius RB and which has a center g, the imaginary osculating circle 64 becomes more stable.

According to the present invention, by embodying the theory of virtual point contact, the problem of variations in tightening torque and locking performance, which occurred due to an inclination of a torque nut 40, which occurs due to a clearance between an external thread and an internal thread, and an inclination of a base nut 20, which occurs due to the deformation of a rolled internal thread mainly caused by a tapping operation using a bent shank tap is solved, and a nut set that enables an unskilled person to perform uniform and certain fastening can be obtained.

In addition, a production method and a management method for metal molds by which a nut set having international competitiveness, such as stable quality, cost reduction, weight reduction, energy saving, operation safety, and risk reduction can be obtained were found.

### BRIEF DESCRIPTION OF DRAWINGS

FIG. 1 (a) and FIG. 1(b) are diagrams illustrating a comparison principle of contact cross sections substantially perpendicular to a bolt axis, and FIG. 1(a) and FIG. 1(b) respectively illustrate the present invention and the related art.

FIG. 2 is a sectional view in a direction in which the bolt axis extends illustrating an embodiment of a nut set according to the present invention.

FIG. 3 is a sectional view in the direction in which the bolt axis extends illustrating a nut set of the related art.

FIG. 4 is a sectional view in the direction in which the bolt axis extends illustrating another embodiment of the nut set according to the present invention.

FIG. 5 is a view as seen in the direction of arrow A of FIG. 2.

FIG. 6 is a view as seen in the direction of arrow A of FIG. 4.

FIG. 7 is a principle diagram of another example of a contact cross section substantially perpendicular to the bolt axis according to the present invention.

FIGS. 8(a) and 8(b) are sectional views illustrating a method of manufacturing a production metal mold according to the present invention, and FIG. 8(a) and FIG. 8(b) respectively illustrate the middle of the manufacturing process and a finished product.

FIG. 9 is a flowchart of a process of producing the nut set according to the present invention.

FIGS. 10(a) and 10(b) are comparison side views illustrating fitting of the nut set according to the present invention, and FIG. 10(a) and FIG. 10(b) respectively illustrate the nut set according to the present invention and a nut set of the related art.

FIG. 11 is a principle diagram of another example of a contact cross section substantially perpendicular to the bolt axis according to the present invention.

FIG. 12 is a sectional view in the direction in which the bolt axis extends illustrating another embodiment of the nut set according to the present invention.

### DESCRIPTION OF EMBODIMENTS

Embodiments of the present invention will be described in detail below. First, recent advances in technology will be described.

Almost all bolts and nuts have been produced by the thread rolling method, which is plastic working. Bolts are external threads, and nuts are internal threads. Although rolling of external threads has rapidly become popular because it was easy to perform, it is difficult to perform rolling of internal threads, and a tapping operation using a bent shank tap is the only method of rolling internal threads as of now. Although it will be described in detail later, it is an object of the present invention to solve this problem.

Note that the production output of bolts and nuts in Japan is about 900 billion yen per year, and the internal mass ratio of the nuts to the bolts is unexpectedly large.

Cold precision forging also has rapidly become popular for the following reasons. Cold precision forging is a resource-saving method that will not generate swarf, a multistage former processing machine has been developed, and fabrication of a complex metal mold at low cost by using an NC machine has become available.

In addition, it is now possible to determine production behavior and stress and the like owing to advances in a computer analysis technology and computing speed.

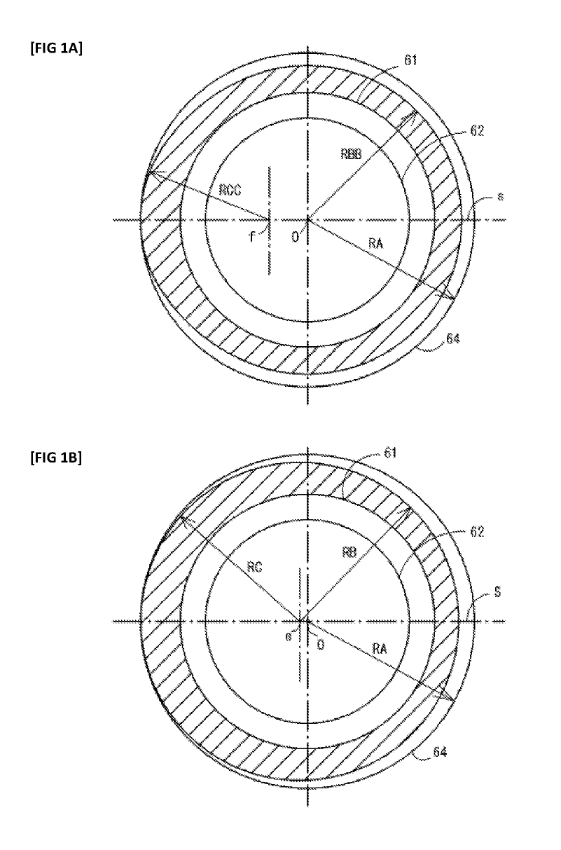

FIGS. 1(a) and 1(b) are diagrams illustrating a comparison principle of contact cross sections substantially perpendicular to a bolt axis, and FIG. 1(a) and FIG. 1(b) respectively illustrate the present invention and the related art. Since a turning operation has been used in the related art, RB having an eccentric center e that is slightly spaced apart, to the left, from a center o of a radius RA is a perfect circle RB having a radius smaller than RA by an amount equal to a space S, and RB is equal to RC and is in contact with an imaginary osculating circle 64 at the leftmost point. In contrast, according to the present invention, a radius RBB extends from the center o of the radius RA, and a small space s between RBB and the imaginary osculating circle 64 does not change within an angular range equal to or greater than the semicircumference of the imaginary osculating circle 64 including an upper portion, a right portion, and a lower portion of the imaginary osculating circle 64. A center f of a radius RCC is significantly spaced apart from the center o of the radius RA to the left. An arc of the radius RCC, which extends from f, is in contact with the imaginary osculating circle 64 at the leftmost point, and RCC and RBB are smoothly continuous with each other.

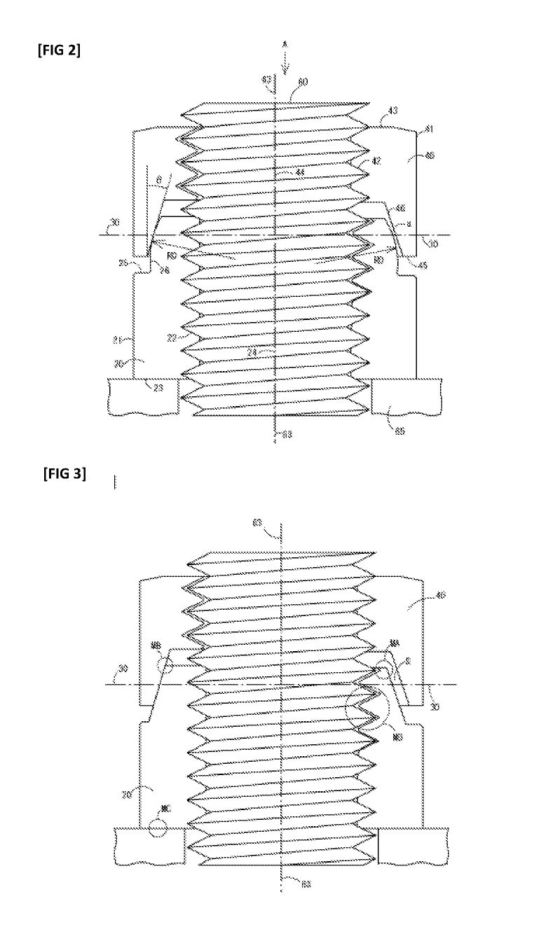

FIG. 2 is a sectional view in a direction in which a bolt axis extends illustrating an embodiment of a nut set according to the present invention. The imaginary osculating circle 64 will now be described.

When a torque nut 40 and a bolt 60 function in pairs while being concentric with each other, the imaginary osculating circle 64 is located on an imaginary contact surface 30, which is a surface as seen in the direction of arrow A passing through a contact point of the base nut 20 and the torque nut 40, and is a perfect circle formed of a conical recessed surface 46 of the torque nut 40. Thus, when the torque nut 40 is inclined, the imaginary osculating circle 64 is also inclined. Although, in general, the imaginary osculating circle 64 is not limited to being concentric with a bolt axis 63 and is not limited to crossing at right angles to the bolt axis 63, in FIGS. 1(a) and 1(b), the imaginary osculating circle 64 is considered to be located on the imaginary contact surface 30 and is illustrated in such a manner as to have the radius RA.

Although the contact point is technically a plane, a position at which a maximum contact pressure is generated will be referred to as the contact point.

Since the contact point moves in a spiral manner on the conical recessed surface 46 as the torque nut 40 is tightened, the perfect circle radius RA of the imaginary osculating circle 64 has a property of gradually becoming small.

A conical inclination angle θ may be about 10 degrees, and an axial direction radius RD may be about one-tenth of the outer diameter 61 of the bolt (nominal diameter d). As long as the contact pressure in a protruding portion having the axial direction radius RD is not larger than the elastic limit of a steel material, as the contact pressure becomes larger, the protruding portion may clearly serve as a fulcrum. Note that Hert'z Formula described in NPL 1 is used for calculating the contact pressure. The gist of the present invention can be described by using the imaginary osculating circle 64.

FIG. 3 is a sectional view in the direction in which the bolt axis extends illustrating a nut set of the related art. An internal thread of the base nut 20 includes a thin portion MA, and a core thereof is inclined toward the right side, and thus, when trying to generate a desired axial tension PT by tightening the base nut 20 first, an off-center contact pressure is generated in a portion MC, and when the base nut 20 is eventually tightened to a predetermined tightening torque, a gap is formed in a portion MD.

Subsequently, when the torque nut 40 is tightened, the torque nut 40 is brought into contact with a portion MB first. This will be better understood when a test is conducted by applying a marker onto a tapered surface of a nut set. That is to say, the imaginary contact surface 30 initially passes through the portion MB, and the tightening torque in this case is zero. Then, as the torque nut 40 is further tightened, the torque nut 40 gradually becomes inclined toward the right side while MB serves as a fulcrum, and the tightening torque increases. However, the tightening torque suddenly decreases at a certain point, and the imaginary contact surface 30 moves down. After that, final tightening of the torque nut 40 is performed, and the torque nut 40 can be tightened to a predetermined tightening torque.

There are variations of this phenomenon. There is a case where this phenomenon occurs twice, and there is a case where this phenomenon occurs with a clunking sound. Such variations occur because RB is large, and the position of a fulcrum of a tapered surface is unclear.

Note that details of an inclination of a torque nut are illustrated in FIG. 1 and FIG. 3 of PTL 2.

In FIG. 3, the imaginary contact surface 30 that changes is tentatively illustrated in the vicinity of a center portion.

Returning to FIG. 2, according to the gist of the present invention, the contact point, through which the imaginary contact surface 30 passes, moves up in a spiral manner on the conical recessed surface 46 of the torque nut 40, and thus, while the radius of the imaginary osculating circle 64 is gradually decreasing, the tightening torque monotonically increases (without a sudden drop), so that a consistent locking performance can be obtained.

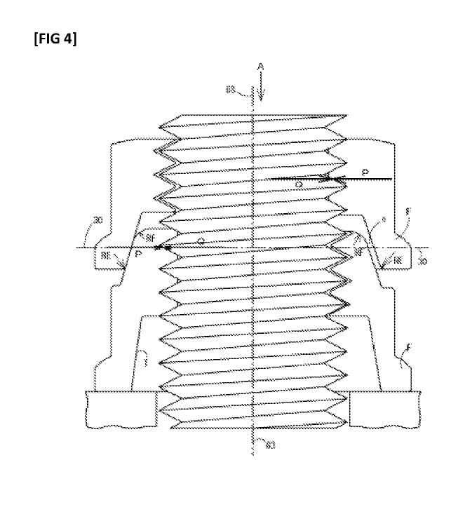

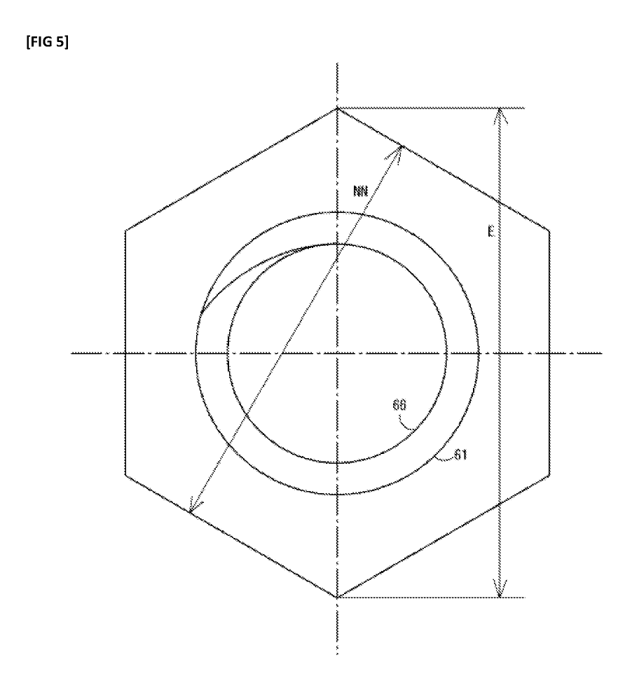

FIG. 4 is a sectional view in the direction in which the bolt axis extends illustrating another embodiment of the nut set according to the present invention. With this embodiment, good results were obtained from test production and experiments, and in this embodiment, a large chamfer radius RF of a top surface of the base nut and a chamfer radius RE of a bottom surface of the torque nut are reduced by using a lathe.

FIG. 4 illustrates the occurrence of a locking force. A bolt reaction force Q is generated in response to a torque nut pressing force P in such a manner that the torque nut pressing force P and the bolt reaction force Q act as a couple of forces. As a result, the bolt axis 63 is inclined, and friction is generated such that the torque nut 40 is hindered from rotating.

In addition, in FIG. 4, a thickness-reduced portion T is formed in a flange portion F of the base nut 20 in such a manner that the length of the torque nut 40 and the length of the internal thread are the same as each other, so that an improvement in the efficiency of a tapping operation using a bent shank tap, weight reduction, and material saving are achieved.

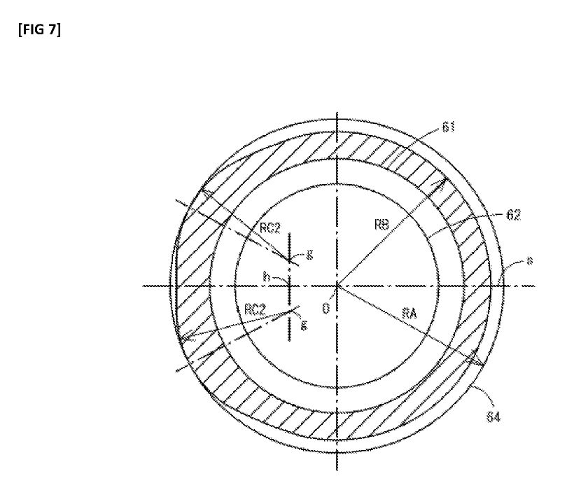

FIG. 7 is a principle diagram of another example of a contact cross section substantially perpendicular to the bolt axis according to the present invention.

A radius midpoint h for two noses of a cam is set on the left side of the center o of the imaginary osculating circle 64, and a center g of a radius RC2 is set on opposite sides of the radius midpoint h. Then, the two cam noses each of which has the small radius RC2 having the center g.

Although the shape of the cam is complex, there are two contact points, and the imaginary osculating circle 64 becomes more stable. In manufacture of metal molds, there will be no increase in manufacturing costs by modifying only a program that controls an axis NCC of a milling cutter by using a CNC system.

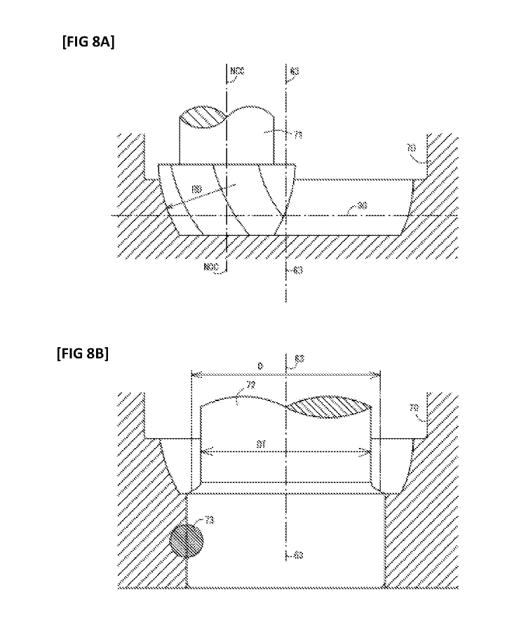

FIGS. 8(a) and 8(b) are sectional views illustrating a method of manufacturing a production metal mold 70 for the base nut 20 according to the present invention, and FIG. 8(a) and FIG. 8(b) respectively illustrate the middle of the manufacturing process and a finished product. In the middle of the manufacturing process illustrated in FIG. 8(a), the axis NCC of a milling cutter 71 is controlled by the CNC system, and a profiling operation is performed. The axial direction radius RD may be given to the milling cutter 71. Regarding the finished shape of the metal mold 70 illustrated in FIG. 8(b), a pilot-hole piercing pin 72 is provided in such a manner as to have the bolt axis 63 of the production metal mold 70 as its axis and is fixed in place with a taper pin 73.

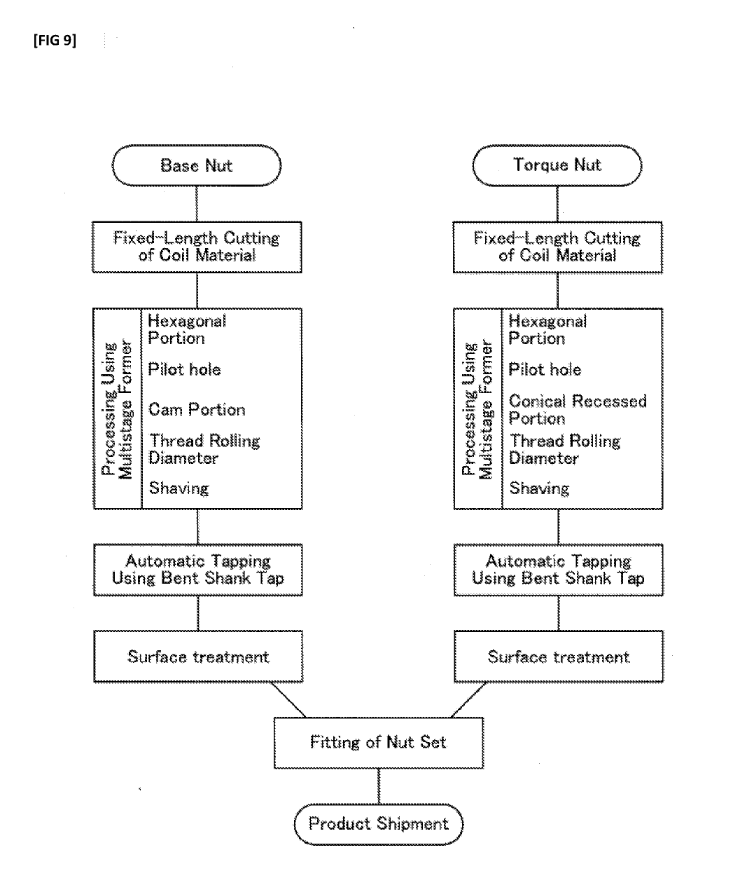

FIG. 9 is a flowchart of a process of producing the nut set according to the present invention.

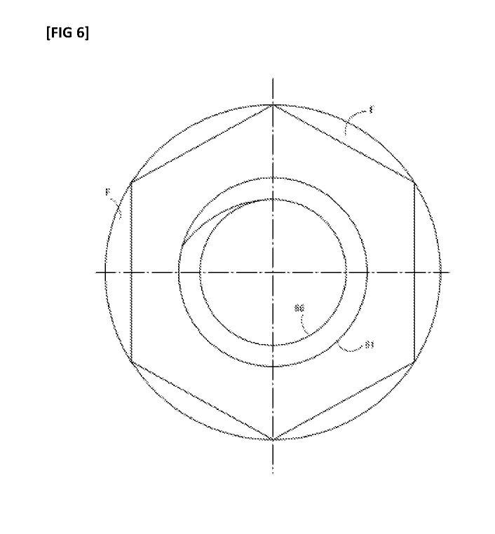

The base nut 20 and the torque nut 40 are produced through substantially the same process, and each of the base nut 20 and the torque nut 40 is completed by performing a surface treatment thereon through an automatic tapping operation using a bent shank tap. It is difficult to perform the automatic tapping operation using a bent shank tap on a nut that includes a flange portion F as illustrated in FIG. 6, and the automatic tapping operation using a bent shank tap can be performed only on a nut in the form of a regular hexagonal column as of now. Although a surface treatment is usually essential in the case of using a steel material, such a surface treatment is not necessary in the case of using stainless steel SUS304.

In the case of an M16 coarse thread, the mass of the base nut 20 and the mass of the torque nut 40 are 26 g and 23 g, respectively, and the mass of the base nut 20 can be reduced to a value equal to or less than the mass of the torque nut 40 by applying the present invention.

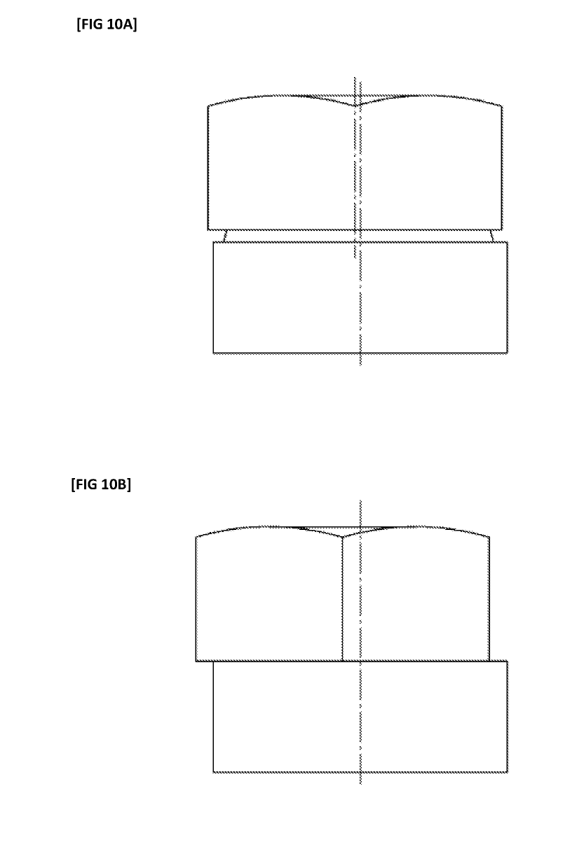

A feature of the production method according to the present invention is fitting of the nut set. Since the base nut 20 and the torque nut 40 are always paired with each other as a set, it would be convenient if they are fitted beforehand to each other. As illustrated in FIGS. 10(a) and 10(b), since a relationship of space s of the present invention (FIG. 10(a))<space S is satisfied, friction bonding occurs, and the base nut 20 and the torque nut 40 can be separated from each other by hand with no scratches. In addition, automated fitting of the base nut 20 and the torque nut 40 can be performed by using a feeder.

FIG. 11 is a principle diagram of another example of a contact cross section perpendicular to the bolt axis according to the present invention.

From a functional standpoint, an island A (SIA) is enough for a circumferential protruding portion of the base nut 20. Considering the fitting of the nut set, an island B (SIB) is also required, and this idea contributes to a weight reduction.

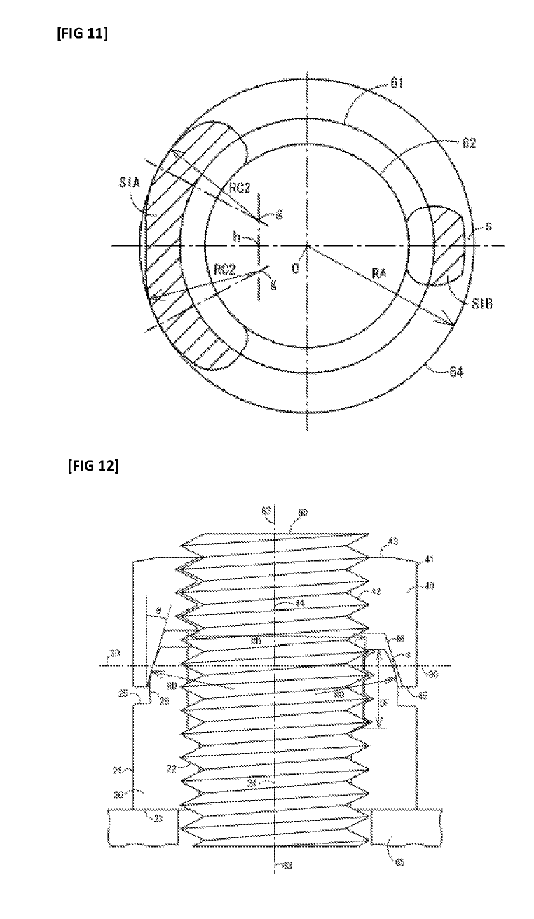

FIG. 12 is a sectional view in the direction in which the bolt axis extends illustrating another embodiment of the nut set according to the present invention.

FIG. 12 illustrates a case where a weight reduction is achieved by forming a thickness-reduced portion having a diameter DD and a depth DF from the circumferential protruding portion of the base nut 20. This facilitates machining of an internal thread rolling portion, and there will not be a problem with the deformation of an internal thread due to a tapping operation using a bent shank tap.

According to the present invention, an essential tightening torque monotonically increases, and a consistent locking performance can be obtained by improving the function of the base nut 20 (the improvement may be so small as to be unrecognizable) without changing the configuration of the torque nut 40 from that of a product of the related art.

Logically, it would appear that a similar locking performance can be obtained by improving the function of the torque nut 40 (the improvement may be so small as to be unrecognizable) without changing the configuration of the base nut 20 from that of a product of the related art. However, such a locking performance could not be obtained when studies were actually conducted.

The present invention relates to an embodiment of the theory of virtual point contact and a method of producing a metal mold by which a nut set having international competitiveness, such as stable quality, cost reduction, weight reduction, energy saving, operation safety, and risk reduction is obtained, and test production and experiments have already been conducted so that the present invention is industrially applicable immediately.

Reference Signs List

10 nut set

20 base nut

21 regular hexagonal column

22 rolled internal thread

23 lower end surface

24 shaft core

25 upper end surface

26 inclined cam

30 imaginary contact surface

40 torque nut

41 regular hexagonal column

42 rolled internal thread

43 upper end surface

44 shaft core

45 lower end surface

46 conical recessed surface

60 bolt

61 outer diameter of bolt (nominal diameter d)

62 inner diameter of rolled internal thread

63 bolt axis

64 imaginary osculating circle

65 fixture

66 root diameter of bolt

70 metal mold

71 milling cutter

72 pilot-hole piercing pin

73 taper pin

d nominal diameter (outer diameter of bolt)

e eccentric center

f center of radius RCC

g center of radius RC2

h radius midpoint for two noses of cam

o center of radius RA

s small space

D root diameter of rolled internal thread (nominal diameter)

DD diameter of enlarged rolled internal thread

DF depth of diameter of enlarged rolled internal thread

DT diameter of rolled internal thread

E width across corner

F flange portion

NCC axis of milling cutter

NN width across flat

MA thin portion

MB crushed portion of base nut

MC off-center contact pressure portion

MD thickness deviation tap clearance portion

P torque nut pressing force

PJ axial tension

Q bolt reaction force

RA radius of imaginary osculating circle

RB radius smaller than RA by amount equal to space S

RBB radius smaller than RA by amount equal to space s

RC radius smaller than RB

RCC radius smaller than RBB

RC2 small radius having center g

RD axial direction radius

RE chamfer radius of bottom surface of torque nut

RF large chamfer radius of top surface of base nut

S large space

T thickness-reduced portion

SIA island A

SIB island B

α helix angle of pitch diameter

θ conical inclination angle

1: A locking nut set comprising:
a base nut; and
a torque nut,
wherein the base nut includes a regular hexagonal column as a peripheral portion of the base nut and a rolled internal thread that is formed in a center shaft core of the base nut,
wherein a lower end surface of the regular hexagonal column is a plane perpendicular to the shaft core,
wherein, on an upper end surface of the regular hexagonal column, a radius RBB, which is concentric with an imaginary osculating circle having a radius RA substantially perpendicular to a bolt axis and which is smaller than the radius RA by an amount equal to a space, forms at least half or more of a circumference of the imaginary osculating circle,
wherein, in a remaining portion, a radius RCC, which is smaller than the radius RBB, is in contact with the imaginary osculating circle, and a rib-shaped inclined cam, which is continuous with the radius RBB, is formed,
wherein a portion of the inclined cam that is in contact with the imaginary osculating circle in a sectional view in an axial direction includes a convex surface having a radius RD,
wherein the torque nut includes a regular hexagonal column as a peripheral portion of the torque nut and a rolled internal thread that is formed in a center shaft core of the torque nut,
wherein an upper end surface and a lower end surface of the regular hexagonal column are each a plane perpendicular to the shaft core,
wherein the torque nut includes a conical recessed surface, which extends from the lower end surface and has the shaft core as a center of the conical recessed surface and a conical inclination angle, and
wherein the locking nut set has a structure in which the base nut is tightened first onto a bolt in such a manner as to generate a desired axial tension, and after that, the torque nut is tightened.

2: A locking nut set comprising:
a base nut; and
a torque nut,
wherein the base nut includes a regular hexagonal column as a peripheral portion of the base nut and a rolled internal thread that is formed in a center shaft core of the base nut,
wherein a lower end surface of the regular hexagonal column is a plane perpendicular to the shaft core,
wherein, on an upper end surface of the regular hexagonal column, a radius RBB, which is concentric with an imaginary osculating circle having a radius RA substantially perpendicular to a bolt axis and which is smaller than the radius RA by an amount equal to a space s, forms at least half or more of a circumference of the imaginary osculating circle,
wherein, in a remaining portion, a radius RCC, which is smaller than the radius RBB, is in contact with the imaginary osculating circle, and a rib-shaped inclined cam, which is continuous with the radius RBB, is formed,
wherein an upper portion of a portion of the inclined cam that is in contact with the imaginary osculating circle in a sectional view in an axial direction at least includes a rounded surface RF facing the upper end surface,
wherein the torque nut is the same as the torque nut according to claim 1, and
wherein the locking nut set has a structure in which the base nut is tightened first onto a bolt in such a manner as to generate a desired axial tension, and after that, the torque nut is tightened.

3: A locking nut set comprising:
a base nut; and
a torque nut,
wherein the base nut includes a regular hexagonal column as a peripheral portion of the base nut and a rolled internal thread that is formed in a center shaft core of the base nut,
wherein a lower end surface of the regular hexagonal column is a plane perpendicular to the shaft core,
wherein, on an upper end surface of the regular hexagonal column, a radius RBB, which is concentric with an imaginary osculating circle having a radius RA substantially perpendicular to a bolt axis and which is smaller than the radius RA by an amount equal to a space, forms at least half or more of a circumference of the imaginary osculating circle,
wherein a rib-shaped inclined cam, which is in contact with the imaginary osculating circle and is continuous with the radius RB, is formed in a remaining portion, and two noses of the cam are present in the remaining portion, each of the noses having a radius RC2, which has a center g and which is smaller than the radius RB,
the torque nut is the same as the torque nut according to claim 1, and
wherein the locking nut set has a structure in which the base nut is tightened first onto a bolt in such a manner as to generate a desired axial tension, and after that, the torque nut is tightened.

4: The locking nut set according to claim 1, wherein an island SIA and an island SIB or only the island SIA is formed by partitioning a peripheral rib of the rib-shaped inclined cam.

5: The locking nut set according to claim 1, wherein a thread rolling hole diameter of the rolled internal thread, which is threaded in the center shaft core of the base nut, is set in such a manner that the rolled internal thread has a depth DF from a top surface and an enlarged hole diameter DD.

6: The locking nut set according to claim 1, wherein the base nut includes a flange in a lower portion of the base nut, and a thickness-reduced portion is formed in the lower portion of the base nut.

7: The locking nut set according to claim 1, wherein the locking nut set has an axial direction radius RD in a vicinity of at least the portion of the rib-shaped inclined cam that is in contact with the imaginary osculating circle.

8: A production method for a base nut, wherein, in the locking nut set according to claim 1, the rib-shaped inclined cam is formed by cold heading die stamping using a multistage former.

9: A production method for a base nut, wherein, in the locking nut set according to claim 1, by controlling an axis NCC of a milling cutter by a CNC system, a curve of the imaginary osculating circle of the rib-shaped inclined cam is given to a metal mold that is used in cold heading using a multistage former.

10: A production method for a locking nut set, wherein, in the locking nut set according to claim 1, the base nut and the torque nut, which are paired with each other, are fitted to each other before use.

11: The locking nut set according to claim 2, wherein an island SIA and an island SIB or only the island SIA is formed by partitioning a peripheral rib of the rib-shaped inclined cam.

12: The locking nut set according to claim 3, wherein an island SIA and an island SIB or only the island SIA is formed by partitioning a peripheral rib of the rib-shaped inclined cam.

13: The locking nut set according to claim 2, wherein a thread rolling hole diameter of the rolled internal thread, which is threaded in the center shaft core of the base nut, is set in such a manner that the rolled internal thread has a depth from a top surface and an enlarged hole diameter DD.

14: The locking nut set according to claim 3, wherein a thread rolling hole diameter of the rolled internal thread, which is threaded in the center shaft core of the base nut, is set in such a manner that the rolled internal thread has a depth DF from a top surface and an enlarged hole diameter DD.

15: The locking nut set according to claim 2, wherein the base nut includes a flange in a lower portion of the base nut, and a thickness-reduced portion is formed in the lower portion of the base nut.

16: The locking nut set according to claim 3, wherein the base nut includes a flange in a lower portion of the base nut, and a thickness-reduced portion is formed in the lower portion of the base nut.
